(19) United States
(12) Patent Application Publication
(10) Pub. No.: US 2019/0178442 A1
(43) Pub. Date: Jun. 13, 2019

(54) PROTECTIVE COVER

(71) Applicant: ATELIER SYSTEMES DE PROTECTION, SAS, Eulmont (FR)

(72) Inventors: Philippe Petit, Millery (FR); Fabien Grandieu, Eulmont (FR); Philippe Pichon, Eulmont (FR); Pierre Arditti, Laxou (FR)

(73) Assignee: ATELIER SYSTEMES DE PROTECTION, SAS, Eulmont (FR)

(21) Appl. No.: 16/306,680

(22) PCT Filed: May 31, 2017
(86) PCT No.: PCT/EP2017/063235

§ 371 Date: Dec. 3, 2018

(30) Foreign Application Priority Data
Jun. 3, 2016 (FR) 1655101

(51) Int. Cl. F16P 1/06; B23K 11/36; B23K 37/00

(52) U.S. Cl. CPC F16P 1/06; B23K 37/006; B23K 11/36

(57) ABSTRACT

A protective cover for equipment, in particular for welding apparatuses, includes a front panel (1) and at least two side panels, each having a main part (31, 41), the side panels being connected to one another in order to form a tubular surrounding member and the side panels being connected to the front panel. In order to adapt easily the cover to equipment of different sizes, at least one of the side panels has a flap (23, 33, 43, 53) which can be folded and fastened on one of the side panels so as to close the cover. The front part of the equipment is protected by the front panel, to which are fastened the side panels connected to one another. At the rear part, which is less exposed, the flap of a side panel is folded and fastened on one of the side panels by the fastening means.

The invention relates to a protective cover for equipment, in particular for welding apparatuses, the cover comprising a front panel and at least two side panels, each side panel comprising a main part, the front panel and the side panels being provided with connecting means to connect the side panels to one another in order to form a tubular surrounding member and to connect the side panels to the front panel.

The document EP 1 504 228 B1 describes a protective cover for welding apparatuses, in particular spot welding tongs. This cover resists welding splatter and is non-flammable. It is constituted by a front panel, a rear panel and a separate tubular surrounding member to be arranged between the front and rear panels. The front panel and the rear panel are provided with connection and adjustment means to connect them to each other and to adjust the distance between them. They are substantially planar and protect the part of the apparatus provided with welding tongs and the part opposite to the latter. The tubular surrounding member protects the part located between the panels. It is constituted by several panels connected to one another so that the surrounding member better matches the circumference of the welding apparatus.

These covers have a proven track record, but they are usually custom-sized covers for a certain type of welding apparatus.

The document U.S. Pat. No. 4,660,610 describes an insulating cover for storing a welding torch. This cover is constituted by a one-piece T-shaped panel which is folded over itself along the central branch of the T so as to form an inverted L-shaped cover. The outer edge of the vertical branch of the L, formed by the middle of the central branch of the T, is closed. The upper edges of the lateral branches of the T are sewn together so as to form the outer edge of the horizontal branch of the L, while the lower edges and the ends of the lateral branches are connected to each other by means of rings so as to form the inner edge and the end of the horizontal branch of the L. In this state, the cover is open at the lower end and inner edge of the vertical branch of the L. This opening allows the introduction of a torch in the cover. Once the torch is placed in the cover, the inner edge of the vertical branch can be closed in turn by a flap made in the extension of one of the lateral edges of the central branch of the T. This flap, which is made in the same piece as the rest of the cover, can be folded on the opposite edge of the opening so as to form, with the rest of the vertical part of the cover, a tubular sleeve surrounding the torch. The lower end of the cover remains open and allows in particular the passage of the power cables of the torch. This cover is not intended to protect the torch during use, but to store it temporarily during a short interruption of welding.

The document WO 2015/036847 A1 discloses batteries intended for a welding operation. These batteries are surrounded by an insulating structure. In particular, various welding batteries can be provided with one or more battery casings that can be opened or closed to increase or decrease their insulation effect. In some embodiments, the battery casings can be integrated with batteries used in hybrid welding machines. Depending on the need, the envelope is thus opened during use to prevent the battery from overheating.

The objective of the invention is to design a cover according to the preamble that can be adapted easily to equipment having different sizes. The cover must protect the object during its use, while being easy to disassemble when the protected object is no longer in operation, either to replace the cover or one of its components, or to access the protected object to modify, maintain or repair it.

This objective is achieved by a cover conforming to the preamble in which at least one of the side panels has a flap that can be folded and fastened on one of the side panels with fastening means so as to close the cover.

At least one side panel thus comprises a main part intended for the formation of the tubular surrounding member and a flap intended to be folded over the rear of the equipment to be protected. The flap allows a quick adaptation of the size of the cover to the size of the equipment to be protected. Indeed, the front part of the equipment is protected by the front panel, the sides are protected by the tubular surrounding member formed by connecting the main parts of the side panels with one another, the tubular surrounding member being itself connected to the front panel. At the rear part, which is less exposed, the flap of at least one side panel is folded and fastened on another side panel by the fastening means, thus closing the cover on the equipment. This fastening can be clone on the main part of a side panel, for example the side panel located opposite to it.

When the cover is provided with several flaps, the flaps can, in the folded and fastened position, overlap at least partly the flap of one or several other side panels, in particular the flap of the neighboring side panels. The fastening of the flap or flaps can be clone on the main part of a side panel and/or on another flap.

One or more panels can be designed to get around a support on which the equipment to be protected is fixed. The panel or panels can get around the support either at their main part or at their flap. To get around the support, a notch can be provided in the panel or the flap, for example. It is also possible to let the support pass between the adjacent edges of two successive panels or to wind at least partially one or more flaps around the support. If the object rests on the ground, an opening sufficient to get around the support point will be provided in the tubular surrounding member.

To allow a better adaptation of the cover to the equipment to be protected, it is possible to provide one or more panels with one or more elastic bands in their main part. These elastic bands extend preferably parallel to the front panel.

To monitor easily the inside of the cover or to store utensils, one or more windows or one or more pockets can be made in at least one of the side panels. The window or windows are preferably closed by a transparent flexible material.

It is preferable that the flap has a smaller width than that of the main part. In other words, the flap is narrower than the main part of the panel that participates in forming the tubular surrounding member. Therefore, this flap can be folded more easily than if it had the same width as the rest of the panel, because it can in particular better get around a support on which the equipment is fixed, for example a robot arm carrying a welding apparatus or a support foot.

In a variant of the invention, the side panels have a substantially rectangular main part which is extended by the flap on a side opposite to the front panel.

The width of the flap can decrease continuously to the free end of the flap. This decrease can be provided symmetrically, or only on one side so that one side of the flap remains straight and the other is slanted.

It is also possible to provide that the flap has a substantially constant width throughout its length. Thus, the flap can for example be in the form of a strap which, when closing the cover, can be fastened to the main part of another side panel by means of a loop.

Within the scope of the invention, several types of connecting means and fastening means are provided. They can be constituted by buttonholes, on the one hand, and buttons coming into these buttonholes, on the other hand. The buttons are preferably mushroom buttons, that is to say, buttons constituted by a disk-shaped upper portion, optionally domed, connected to a rigid or semi-rigid rod which is itself attached to the cover. Another solution is to use buttons, preferably mushroom buttons, and hooks intended to be hooked up on the fastening of the button, in particular on the stem of the mushroom button. By choosing a hook whose entryway is slightly narrower than the support of the button, it is ensured that the hook will snap onto the button, which prevents the hook from becoming unhooked by itself. A third solution is to use Velcro®-type self-gripping strips, supplemented if necessary at the ends by snap fasteners. The connecting means and the fastening means can also be constituted by snap fasteners. These different solutions can be used alone or in combination. These connecting or fastening means allow to connect quickly panels to one another and to the front panel and to fasten the flaps on the side panels. In addition, they are strong enough to ensure a sufficient lifespan to the connection and fastening means. Moreover, it is possible, thanks to these fastening means, to adjust the cover to the dimensions of the equipment to be protected.

It is preferable that the components of the cover are made of a material that is non-flammable and resistant to welding splatter.

The use of a protective cover according to the invention for welding equipment, in particular spot welding robots, is also part of the invention.

The invention is described in more detail below with reference to the figures, which show from two different angles:

Uniform covers made only of panels with flaps:

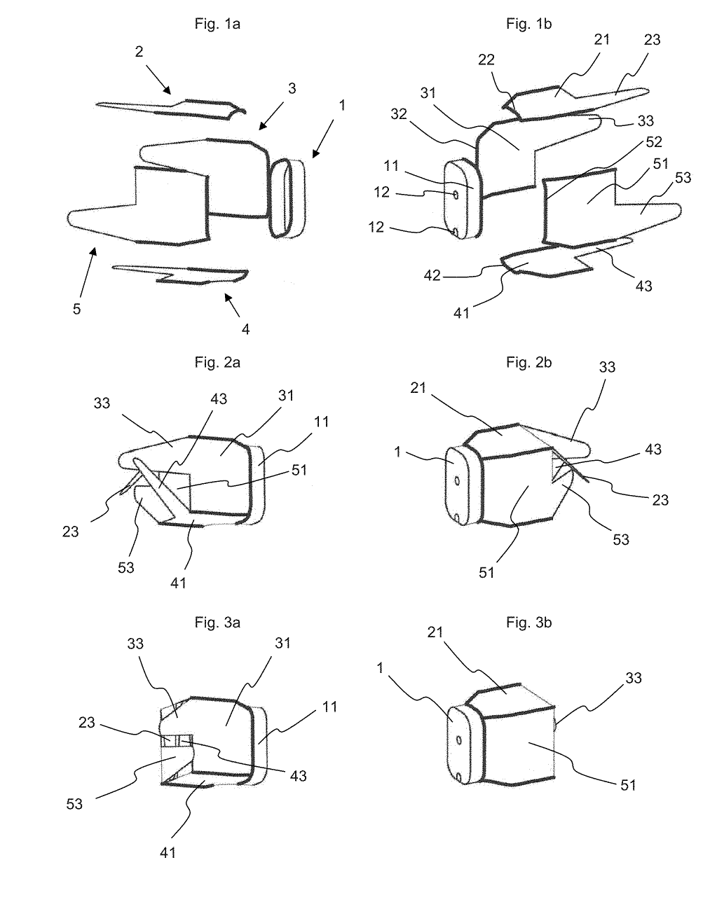

FIGS. 1a and 1b the elements constituting a cover according to the invention before assembly,

FIGS. 2a and 2b the assembled cover before closing it,

FIGS. 3a and 3b the cover completely closed,

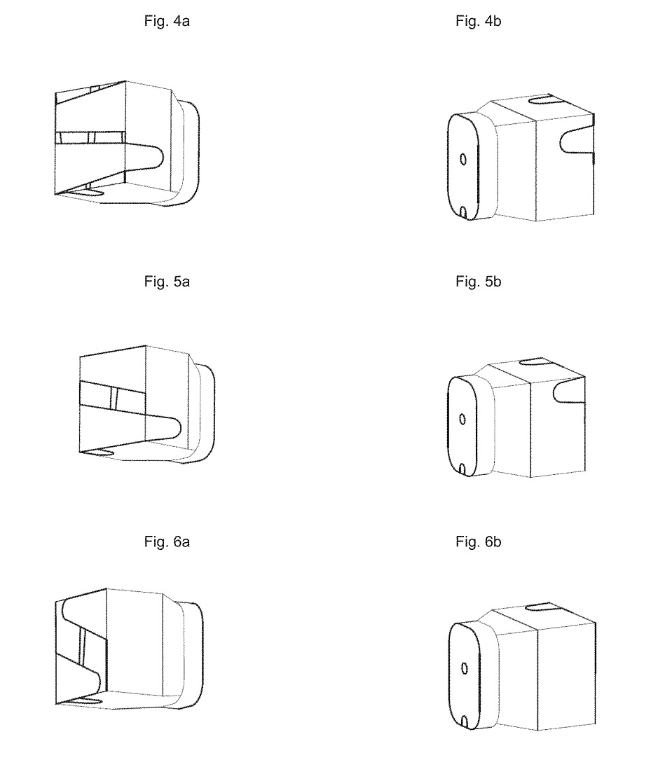

FIGS. 4a and 4b another cover with symmetrical flaps,

FIGS. 5a and 5b another cover with asymmetrical flaps,

FIGS. 6a and 6b another cover with asymmetrical flaps;

Mixed covers made of panels with flaps and panels without flaps:

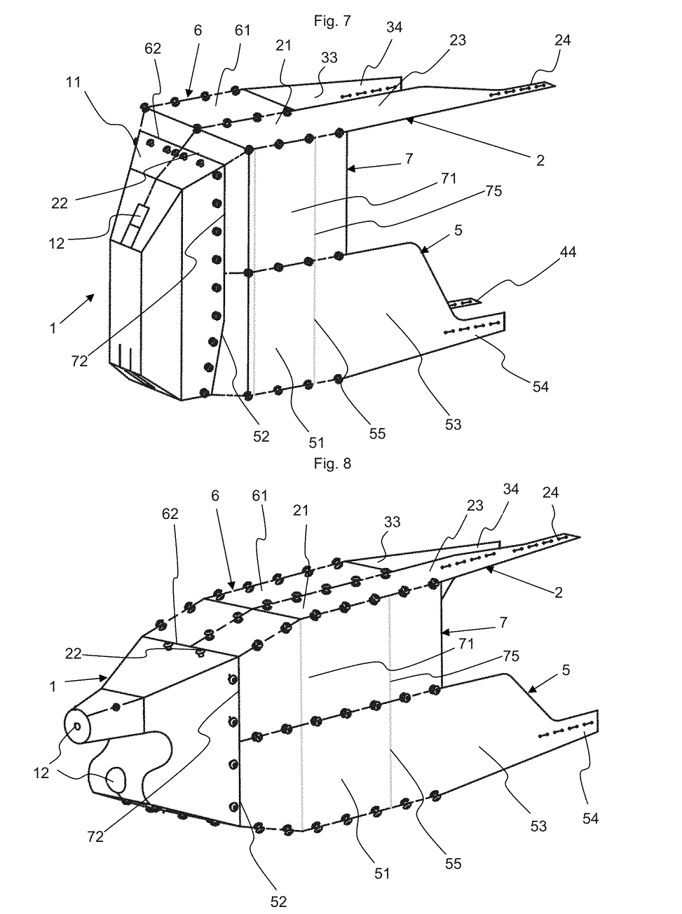

FIG. 7 a cover having 4 panels with flap and 4 panels without flap,

FIG. 8 another cover having 4 panels with flap and 4 panels without flap,

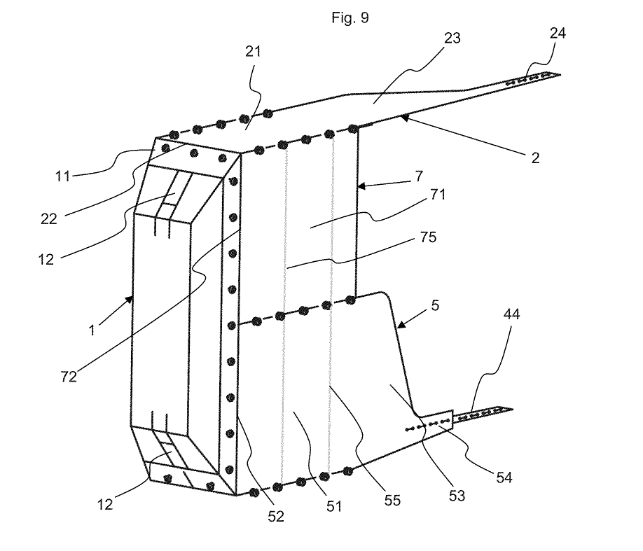

FIG. 9 a cover having 4 panels with flap and 2 panels without flap;

Examples of shapes for side panels with flaps:

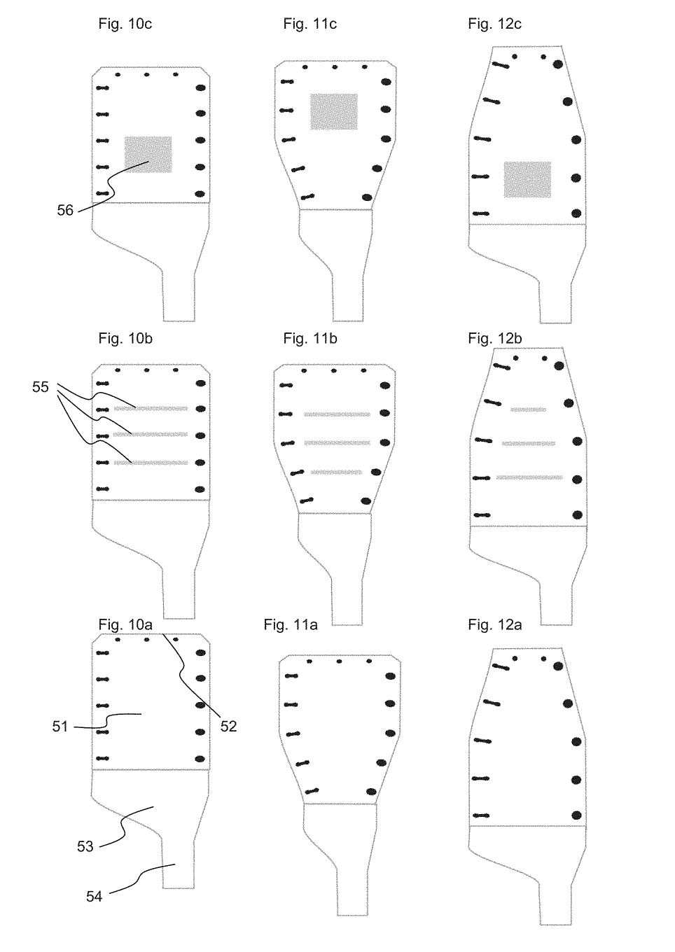

FIGS. 10a to 10c substantially rectangular shapes for substantially cylindrical tubular surrounding members that are (a) simple, (b) with elastic bands and (c) with window or pocket;

FIGS. 11a to 11c shapes narrowing towards the flap for frustoconical tubular surrounding members that are (a) simple, (b) with elastic and (c) with window or pocket;

FIGS. 12a to 12c shapes widening towards the flap for funnel-shaped tubular surrounding members that are (a) simple, (b) with elastic bands and (c) with window or pocket.

The protective cover of the invention is particularly well suited to welding apparatuses mounted on feet or on robots, or placed on the ground. However, it can be used for any other apparatus that needs to be protected, such as from dust or splashing water. It can be used for grippers, for example. The covers shown by way of example in the figures are intended for a spot welding gun. They comprise a front panel (1) and side panels (2, 3, 4, 5, 6, 7). All of these panels (1, 2, 3, 4, 5, 6, 7) are preferably made of a material that is non-flammable and resistant to welding splatter if the cover is intended for a welding apparatus or an apparatus used in foundry.

The front panel (1) has a shape adapted to the front part of the apparatus to be protected. Various shapes of front panels are visible in FIGS. 7, 8 and 9. This front panel can be extended at its periphery by a skirt (11) and it has openings (12) for passing the arms of the welding gun.

The side panels (2, 3, 4, 5, 6, 7) all have a generally polygonal main part (21, 31, 41, 51. 61. 71). One of the edges 32, 42, 52, 62, 72) of the main part, called the front edge, is intended to be connected to the front panel (1). If the main parts are rectangular (see FIGS. 10a/b/c), the tubular surrounding member will have a substantially cylindrical shape. To allow a shape deviating from the cylinder, it can be provided that the lateral edges of the main part approach each other on the side of the front edge (see FIGS. 12a/b/c), so as to give a funnel-type shape to the tubular surrounding member, and/or on the opposite side (see FIGS. 11a/b/c), in that case giving a frustoconical-type shape to the tubular surrounding member. It can also be provided that the lateral edges are convex to give a spherical-type shape with a domed center to the tubular surrounding member.

On the side opposite to the front edge (22, 32, 42, 52, 62, 72) intended to be connected to the front panel, the main part (21, 31, 41, 51) of some side panels is extended by a flap (23, 33, 43, 53) which can be folded and fastened on one of the other side panels (2, 3, 4, 5, 6, 7), preferably the side panel located opposite to it. The width of the flap (23, 33, 43, 53) can decrease and in some cases end with a tab (24, 34, 44, 54). The decrease can be continuous and symmetrical (see FIGS. 1a/b to 4a/b) or continuous and asymmetrical (see FIGS. 5a/b and 6a/b), or alternatively, discontinuous and asymmetrical (FIGS. 7 to 12) or discontinuous and symmetrical. The other side panels (6, 7) are simple panels without flaps and are constituted only by a main part (61, 71).

Some of the side panels (5, 7) can be provided with elastic bands to shirr the cover and thus allow a better adaptation to the shapes of the equipment to be protected. These elastic bands can extend in the direction parallel to the front edge (52, 72) as well as in the direction perpendicular to the front edge. The elastic bands are preferably placed in the main part (51, 71) of the side panel. They can be placed on panels with flap (5) as well as on the simple panels (7).

Similarly, some panels can be provided with a window or a pocket (56) to allow, either to see inside the cover, or to store utensils or spare or replacement parts. The window is preferably made of a flexible and transparent material.

The front panel (1) and the side panels (2, 3, 4, 5, 6, 7) are provided with connecting means (not shown in FIGS. 1 to 6) to connect them to one another and to connect them to the front panel (1).

Quick fastening means are also provided to fasten each flap (23, 33, 43, 53) and/or each tab (24, 34, 44, 54) on another side panel (2, 3, 4, 5, 6, 7). The fastening can be either on the main part (21, 31, 41, 51, 61, 71) of a side panel (see FIGS. 4a/b and 5a/b), or on another flap (23, 33, 43, 53), or one portion of the flaps is fastened on the main part and the other portion on a flap (see FIGS. 6a/b). FIG. 3a/b show a limit case in which the flaps are fastened to the junction between the main part and the flap of the side panel located opposite to it.

For the connecting means and the fastening means, several solutions can be envisioned, among which:
buttonholes and buttons, preferably mushroom buttons, fitting in the buttonholes;
hooks hooking up to the supports of the buttons, preferably the stems of mushroom buttons;
Velcro® type self-gripping strips, optionally supplemented by snap fasteners at the ends;
snap fasteners;
straps that can pass through tightening loops.

It is not necessary that the connecting means and the fastening means are identical. For example, the main parts (21, 31, 41, 51, 61, 71) of the side panels are provided on one side edge with buttonholes and on the other side edge with mushroom buttons, while the flaps are provided at their free end with a hook. Thus, the main parts (21, 31, 41, 51, 61, 71) are connected to one another by buttoning up the mushroom buttons in the buttonholes of the adjacent panel and the flaps (23, 33, 43, 53) are fastened on the main part (21, 31, 41, 51, 61, 71) of the panel located opposite to it (23/41, 33/51, 43/21, 53/31) by hooking up the hook of the flap on one of the mushroom buttons, depending on the size of the equipment to be protected. One can provide mushroom buttons with short stems at the front of the side panel (on the side of the front panel) and mushroom buttons with longer stems at the back of the side panel, where a hook is likely to be hooked up. One can also provide one or more mushroom buttons on the flaps to allow fastening of the hook of a flap on an adjacent flap or on a flap located opposite to it. The hooks can be designed so that their entryway is narrower than the thickness of the stem of the mushroom button on which the hooks are to be fastened. This way, it is ensured that the hooks cannot become unhooked by themselves.

With self-gripping strips, one part of which is placed over the entire length available for fastening the flap, it is also possible to adapt the size of the cover to the equipment to be protected.

When assembling the cover, the side panels (2, 3, 4, 5, 6, 7) are connected to one another to form the tubular surrounding member. They are also connected to the front panel (1) so that there is preferably an overlap between the tubular surrounding member (21, 31, 41, 51, 61, 71) and the skirt (11) of the front panel. The flaps (23, 33, 43, 53) are then folded and fastened on the opposite panel or placed opposite to it, either on the main part (23/41, 33/51, 43/21, 53/31), or on another flap. As shown in FIGS. 2a and 2b, the flaps (23, 33, 43, 53) partly overlap the flap of the two neighboring side panels. By providing more mushroom buttons than necessary or longer self-gripping strips than necessary, it is possible to adapt the size of the cover to that of the equipment to be protected.

FIGS. 3a and 3b show that the cover according to the invention is closed on the side opposite to the front panel (1) in the manner of a cardboard packing box, by folding the flaps (23, 33, 43, 53) on the flaps (23, 33, 43, 53) of the adjacent side panels (2, 3, 4, 5).

In the example shown in the figures, the flap (23, 33, 43, 53), at its junction with the main part (21, 31, 41, 51), is significantly smaller than the corresponding main part. The main part is extended by this flap only on one side. Instead of providing such asymmetrical panels, it is also possible to provide that some panels are not provided with a flap. For example, one can provide simple panels corresponding substantially to half a side and panels also corresponding to a half-panel and extended over their entire width by the flap. When closing the cover, the flaps are folded on another panel, usually a panel without flap. Thus, in this example, there would be four panels with flap and four panels without flap.

Similarly, it can be provided that the flaps are parts separate from the main parts (21, 31, 41, 51) that form the tubular surrounding member, these flaps being connected to the main parts by appropriate connecting means such as those used to connect the side panels to one another and to the front panel.

The flaps can also be constituted by straps which are fastened to a corresponding tightening loop placed on another side panel.

The equipment to be protected can be fixed to a support. It is therefore necessary that the cover get around this support. If the equipment is fixed to a support by its face opposite to the front panel, it is the flaps that get around the support. If the equipment is attached to a support by a side face, either a notch made in the main part of one of the side panels vets around the support, or the support passes between the main parts of two consecutive side panels. If the equipment is placed on the ground, the notch to get around its support point can be made in two consecutive side panels.

The protective covers according to the invention are intended for all types of equipment, including welding guns mounted on robot arms or on feet, and more particularly spot welding robots.

### LIST OF REFERENCES

1 Front panel
11 Side skirt
12 Openings for the clamps
2 Side panel
21 Main part
   22 Edge connected to the front panel
   23 Flap
   24 Tab
3. Side panel
   31 Main part
   32 Edge connected to the front panel
   33 Flap
   34 Tab
4. Side panel
   41 Main part
   42 Edge connected to the front panel
   43 Flap
   44 Tab
5. Side panel
   51 Main part
   52 Edge connected to the front panel
   53 Flap
   54 Tab
   55 Elastic bands
   56 Window/pocket
6. Side panel
   61 Main part
7. Side panel
   71 Main part
   75 Elastic bands

1. Protective cover for equipment, the cover comprising:
a front panel, and
at least two side panels,
wherein each of the panels comprises a main part,
wherein the front panel and the side panels are provided with connecting means to connect the side panels with one another in order to form a tubular surrounding member and to connect the side panels to the front panel
wherein at least one of the side panels has a flap which can be folded and fastened by means of fastening means on one of the side panels so as to close the cover.

2. Protective cover according to claim 1, wherein the cover is provided with several flaps, and wherein, in the folded and fastened position, one or more of the flaps overlap at least partially the flap of one or more other side panels.

3. Protective cover according to claim 1, wherein the flap or flaps is or are fastened on the main part of a side panel and/or on another flap.

4. Protective cover according to claim 1, wherein one or more side panels are designed to get around a support on which the equipment to be protected is fixed.

5. Protective cover according to claim 1, wherein one or more of the side panels is or are provided with one or more elastic bands in its or their main part.

6. Protective cover according to claim 1, wherein one or more windows or one or more pockets is or are made in at least one of the side panels.

7. Protective cover according to claim 1, wherein the flap has a smaller width than the main part of the side panel.

8. Protective cover according to claim 1, wherein the side panels have a substantially rectangular main part which is extended, on a side opposite to the front panel by the flap.

9. Protective cover according to claim 1, wherein the width of the flap decreases continuously to the end of the flap.

10. Protective cover according to claim 1, wherein the width of the flap is substantially constant over the entire length of the flap.

11. Protective cover according to claim 1, wherein the connecting means and/or the fastening means are constituted (i) by buttonholes, and (ii) by buttons intended to fit in the buttonholes.

12. Protective cover according to claim 1, wherein the connecting means and/or the fastening means are constituted (i) by buttons, and (ii) by hooks intended to be hooked up to the support of one of the buttons.

13. Protective cover according to claim 1, wherein the connecting means and/or the fastening means are constituted by self-gripping strips.

14. Protective cover according to claim 1, wherein components of the cover are made of a material that is non-flammable and resistant to welding splatter.

15. Equipment protected by a protective cover according claim 1.

16. Protective cover according to claim 2, wherein one or more of the flaps partially overlap at least partially the flaps of the neighboring side panels.

17. Protective cover according to claim 5, wherein the elastic bands extend parallel to the edge of the side panel intended to be connected to the front panel.

18. Protective cover according to claim 6, wherein one or more windows made of a transparent flexible material is or are made in at least one of the side panels.

19. Protective cover according to claim 11, wherein the buttons are mushroom buttons.

20. Protective cover according to claim 12, wherein the buttons are mushroom buttons, and the hooks are adapted to be hooked up to the stem of one of the mushroom buttons.
